(19) United States
(12) Patent Application Publication
(10) Pub. No.: US 2016/0207459 A1
(43) Pub. Date: Jul. 21, 2016

(54) METHOD FOR MANEUVERING A VEHICLE

(71) Applicant: ROBERT BOSCH GMBH, Stuttgart (DE)

(72) Inventors: Wolfgang Niem, Hildesheim (DE); Harmut Loos, Hildesheim (DE)

(21) Appl. No.: 14/914,686

(22) PCT Filed: Aug. 7, 2014
(86) PCT No.: PCT/EP2014/066954

§ 371 Date: Feb. 26, 2016

(30) Foreign Application Priority Data
Sep. 5, 2013 (DE) 10 2013 217 699.6

(51) Int. Cl. B60R 1/00; G06K 9/00

(52) U.S. Cl. CPC B60R 1/00; G06K 9/00812; B60R 2300/806

(57) ABSTRACT

A method for maneuvering a vehicle and a maneuvering assistance system that allows a precise alignment of the vehicle along structures bounding a parking space or existing in a parking space and is realizable in a cost-effective manner. At a first instant, a first region is sensed by means of a first image and at least one first element is detected inside the first region in the first image and at a second instant, a second region is sensed with the aid of a second image and the position of the first element detected in the first image at the first instant is calculated in relation to the second instant, the first element being inserted as virtual first element into the second image at this calculated position and displayed.

### FIELD

The present invention relates to a method for maneuvering a vehicle, in particular for maneuvering a vehicle in a parking space. The present invention also relates to a maneuvering assistance system.

### BACKGROUND INFORMATION

“Parking assistants” for vehicles such as passenger cars are available. These parking assistants usually are made available by maneuvering assistance systems and by methods for maneuvering vehicles.

More cost-effective maneuvering assistance systems based on reverse travel cameras offer the opportunity of also monitoring the region behind the vehicle on a monitor when driving in reverse. Areas that are not covered by the reverse travel camera, for instance the regions to the side next to the vehicle, are therefore unable to be displayed. In particular at the end of the parking maneuver, the boundary lines or structures otherwise restricting or characterizing the parking space are no longer detected by the maneuvering assistance system in maneuvering assistance systems of this type that are based on reverse travel cameras, and thus are no longer displayed on the monitor.

In addition, what is referred to as surround-view systems are also available. Such surround-view systems are typically based on multiple cameras, such as 3 to 6, and offer an excellent allround view that can be displayed on a monitor of a maneuvering assistance system. As a result, such maneuvering assistance systems allow a precise alignment of a vehicle along parking lines or other structures restricting a parking space. However, the higher costs on account of multiple cameras are disadvantageous in such surround-view systems.

### SUMMARY

It is an object of the present invention to provide a method for maneuvering a vehicle, and to provide a maneuvering assistance system that allows a precise alignment of a vehicle along structures bounding a parking space and that can be made available in a cost-effective manner.

According to the present invention, an example method for maneuvering a vehicle, in particular for maneuvering a vehicle into a parking space, is provided, which includes the following steps:
a) Sensing a first region by means of a first image at a first instant;
b) Detecting at least one first element within the first region in the first image, and/or storing the first image;
c) Sensing a second region with the aid of a second image at a second instant, the second region lying at least partially outside the first region, and the second instance occurring after the first instant;
d) Calculating the position of the first element detected in the first image at the first instance in relation to the second instant, the position lying outside the second region; and/or calculating the position of the first image in relation to the second image; and
e) Inserting the first image and/or the first element into the second image as virtual first element and displaying it at the position calculated in step d).

The vehicle may be any random vehicle, in particular any road vehicle. For example, the vehicle is a passenger car, a truck or a bus.

The regions, such as the first region and the second region, which are sensed at different instants by images, describe outer regions, that is to say, regions that lie outside the vehicle. Preferably, these are horizontal or three-dimensional regions. The individual regions are the regions that are sensed or are able to be sensed by an image recording system, e.g., a camera, on or inside the vehicle. For example, the first region and the second region may be the rear region of a vehicle, which is sensed by a reverse travel camera at the individual instant.

In a step a), the rear region of a vehicle sensable by a reverse travel camera thus is recorded as first region at a first instant with the aid of a first image. Using suitable algorithms, e.g., an algorithm for line detection, a first element within this first region is detected in the first image in step b). As an alternative or in addition, the first image, or the image information of the first image, is stored or buffer-stored in step b). At a second instant, a second region, such as a region that is able to be sensed by a reverse travel camera of the vehicle at this instant, is sensed by a second image in step c). At the second instant, the vehicle preferably is no longer at the same location as at the first instant. In other words, the vehicle has moved between the first instant and the second instant, for instance has backed up. The second region is therefore not identical with the first region, which means that the second region lies at least sectionally or partially outside the first region. For example, the first region and the second region may overlap each other. Furthermore, the first region and the second region may abut each other.

In step d), the position of the detected first element at the second instant is calculated with the aid of suitable algorithms. Since the detected first element is located in the part of the first region that does not overlap the second region and thus lies outside the second region at the second instant, the first element can no longer be detected by an image recording system such as a reverse travel camera, at the second instant. The position of the first element at the second instant is therefore calculated. As an alternative or in addition, the position of the first image in relation to the second instant is calculated in step d). In step e), the first image and/or the first element is inserted as virtual element, e.g., as line drawing, into the second image at this calculated position and displayed.

The particular images, e.g., the first image and the second image, preferably are displayed on a screen or a monitor in the vehicle at the particular instant. The displayed images preferably include more than only the region sensed at this instant. For example, the position of the first element outside the second region is displayed as virtual first element in the second image as well. In addition, for example, the vehicle or at least the current position of the vehicle is shown as further virtual element in the images such as the first image and the second image.

The time intervals of the instants, e.g., the interval between the first instant and the second instant, may have any suitable time interval. For example, these time intervals may lie in the second or millisecond range.

With the aid of the method of the present invention for maneuvering a vehicle, for example, a region sensed by a camera as well as the elements detected in this region can be continually projected into the region outside the region sensed by a camera as a function of the vehicle movement. This gives the driver the opportunity to orient himself at the static structures in the image, for instance.

For example, a current camera image may be augmented by virtual supplemental lines, the positions of which have been calculated using previously detected visible lines. The calculation or implementation preferably may take place on a 3D processor (GPU) of a head unit of the vehicle or the maneuvering assistance system.

It is furthermore preferred that at least one second element within the second region in the second image is sensed in a further step f). As an alternative or in addition, the second image or the image information of the second image is stored or buffer-stored in step f). Preferably in a step g), a third region is then sensed by a third image at a third instant, the third region lying at least partially outside the second region as well as preferably also partially outside the first region. The third instant preferably follows the first and the second instant. In a following step h), the position of the second element detected in the second image at the second instant preferably is calculated in relation to the third instant. The position of the second element detected in the second image at the second instant lies outside the third region. As an alternative or in addition, the position of the second image in relation to the third instant is calculated in step h). Moreover, the second image and/or the second element preferably is inserted into or displayed in the third image as virtual second element at the position calculated in step h), preferably in a next step.

It is furthermore preferred that the individual steps are repeated at predefined time intervals. It would moreover be possible to repeat the individual steps whenever the vehicle has traveled a predefined distance. By repeating the individual method steps, abutting or also partially overlapping further regions are able to be sensed with the aid of further images at successive points in time. Moreover, additional elements within these further regions are detectable in the further images, and the particular positions of the further elements can be calculated in relation to the following point in time and inserted into the current image and displayed therein as virtual further elements.

When the image is output on a monitor of a maneuvering assistance system in the vehicle, for instance, the viewer of the individual current image is given the impression that the vehicle is virtually sliding or moving over the regions sensed at earlier instants.

The method for maneuvering a vehicle preferably is based only on a reverse travel and/or forward travel camera (front camera). The lateral regions next to the vehicle can thus not be sensed by cameras. When viewing the current image on a monitor of a maneuvering assistance system, however, this method makes it possible to continue the display of elements from no longer sensable regions.

The elements such as the first element and/or the second element and/or a third element and/or further elements preferably are what is known as static structures, for instance structures bounding or characterizing a parking space. As a result, these static structures such as lines, for instance, may represent lines that restrict a parking space and are marked on the ground. Moreover, the characterizing structures may be static structures within the parking space, e.g., manhole covers or drains. In particular, these elements are also regions of larger or longer structures which are sensed completely or sectionally by the image recording system such as a camera at the particular instant in time. Furthermore, the static structures may involve curb stone edges, parking vehicles, bollards, guard rails, walls or other structures bounding a parking space.

It is moreover preferred that the part of the first region sensed by the first image and not overlapping the second region is displayed in the second image and outside the second region. As a result, it is preferably provided not only to project detected elements into the next region, but to project complete image information of previously sensed camera images into the particular current image. The projected image portions preferably are characterized as virtual structures. This makes it possible to infer from the current image that a particular region of the image does not constitute “live” information. It is possible, for instance, to display such image portions in the way of comic art (3D art map) in the form of a line drawing, ghost image or vector field.

The calculation of the position of the first element detected in the first image at the first instant preferably takes place in relation to the second instant, based on a movement compensation. That is to say, the position is calculated while taking into account the movement of the vehicle that has taken place between the particular instants, e.g., the first instant and the second instant. The calculation of the position in particular is based on a translation of the vehicle. A translation is a movement in which all points of a rigid body, in this case, the vehicle, undergo the same displacement. Both the path covered, i.e., the distance, and the direction (e.g., when cornering) are sensed. Moreover, the calculation of the position preferably is based on the yaw angle of a camera disposed in or on the vehicle or the yaw angle of the vehicle. The yaw angle is the angle of a rotary motion, or angular motion, of the camera or the vehicle about its vertical axis or the vertical axis of plane. Therefore, taking the yaw angle into account in particular makes it possible to consider the executed change in direction of a vehicle between the respective instants in time in the movement compensation.

In addition, the calculation of the position preferably is also based on a pitch angle and/or roll angle of the camera or the vehicle. The pitch angle is the angle of a rotary or angular motion of the camera or the vehicle about its transverse axis. The roll angle is the roll rate and thus the angle of an angular or rotary motion of the camera or the vehicle about its longitudinal axis. This makes it possible to consider a change in height of the vehicle or the camera in relation to the road surface in the movement compensation.

It is furthermore provided that further image information, e.g., images sensed and recorded at an earlier instant in time, are taken into account and used. Such further image information can be inserted into the current image and displayed. For example, this may also be what is known as external image information. External image information, for example, may be provided on storage media or also by online map services.

According to the present invention, a maneuvering assistance system for a vehicle, in particular for parking, is furthermore provided, the maneuvering assistance system being based on a previously described method for maneuvering a vehicle. The maneuvering assistance system has a first image sensor, disposed on or inside the vehicle and in the rear region of the vehicle, for sensing the first region by means of a first image. For example, the first image sensor is a first camera, in particular a reverse travel camera. Therefore, it is preferably provided that the first image sensor is generally directed toward the rear.

Moreover, the maneuvering assistance system has a second image sensor, disposed on or inside the vehicle and in the front region of the vehicle, for sensing the first region by means of a first image. The second image recording system, for example, is a forward travel camera. Therefore, it is preferably provided that the second image sensor in principle is directed toward the front.

By providing a second image sensor, such as a second camera directed toward the front, the maneuvering assistance system not only is able to provide an assistance system for reverse travel of a vehicle, but for the forward travel of a vehicle as well. For example, a camera facing forward makes it possible to display a parking maneuver on a screen when driving forward as well, because all described features of a method for maneuvering a vehicle are also provided when using a camera directed toward the front.

Furthermore, it is preferably provided that the maneuvering assistance system includes no more than one or two image sensors, in particular cameras.

The maneuvering assistance system furthermore preferably includes especially sensors for sensing the own movement, in particular the translation, of the vehicle. The own vehicle motion preferably is able to be ascertained with the aid of sensors and/or using odometry, an inertial sensor system, the steering angle or directly from the image.

The present invention is explained below on the basis of preferred exemplary embodiments with reference to the figures.

### BRIEF DESCRIPTION OF THE DRAWINGS

FIG. 1 shows a graphic representation of a vehicle in reverse driving at a first instant.

FIG. 2 shows a graphic representation of a vehicle in reverse driving at a second instant.

FIG. 3 shows a graphic representation of a vehicle in reverse driving at a third instant.

FIG. 4 shows a graphic representation of a sequence of multiple images of a parking maneuver of a vehicle.

### DETAILED DESCRIPTION OF EXAMPLE EMBODIMENTS

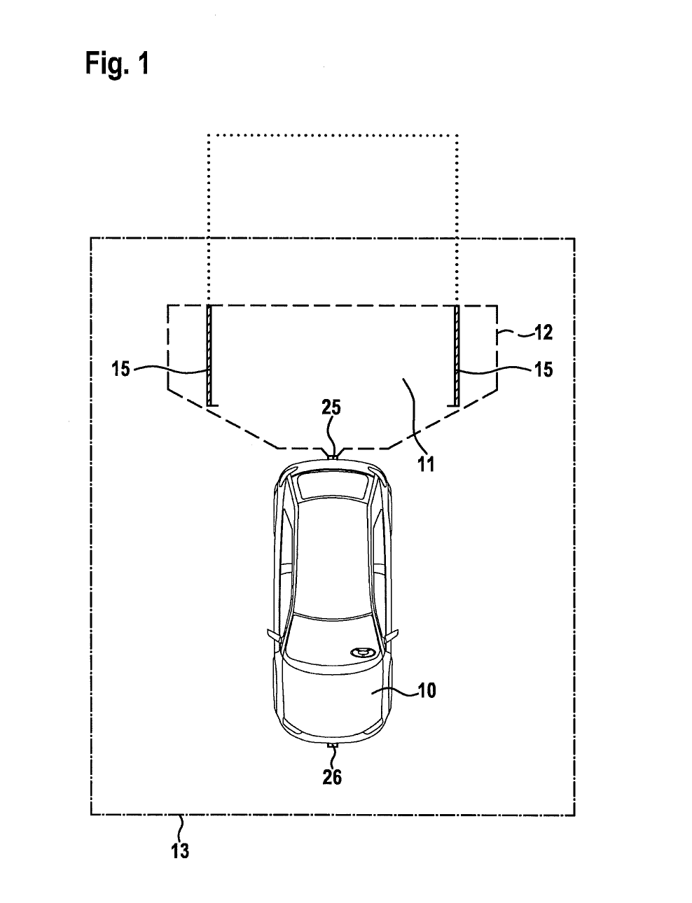

In FIG. 1 a vehicle 10 is shown at the start of a parking maneuver. An image sensor 25, 26, i.e. a camera, is situated both in the rear region of vehicle 10 and in the front region of vehicle 10. Dashed lines denote first region 12 which is detectable and detected by first image sensor 25 in reverse driving of vehicle 10 at first instant 14. Parking space 11 is bounded by lines marked on the ground. The lines lying outside first region 12 are shown as dots in FIG. 1. First elements 15 detected by first image sensor 25 at first instant 14 within first region 12 in each case represent a cut-away portion of the lines of the parking space boundary marked on the ground.

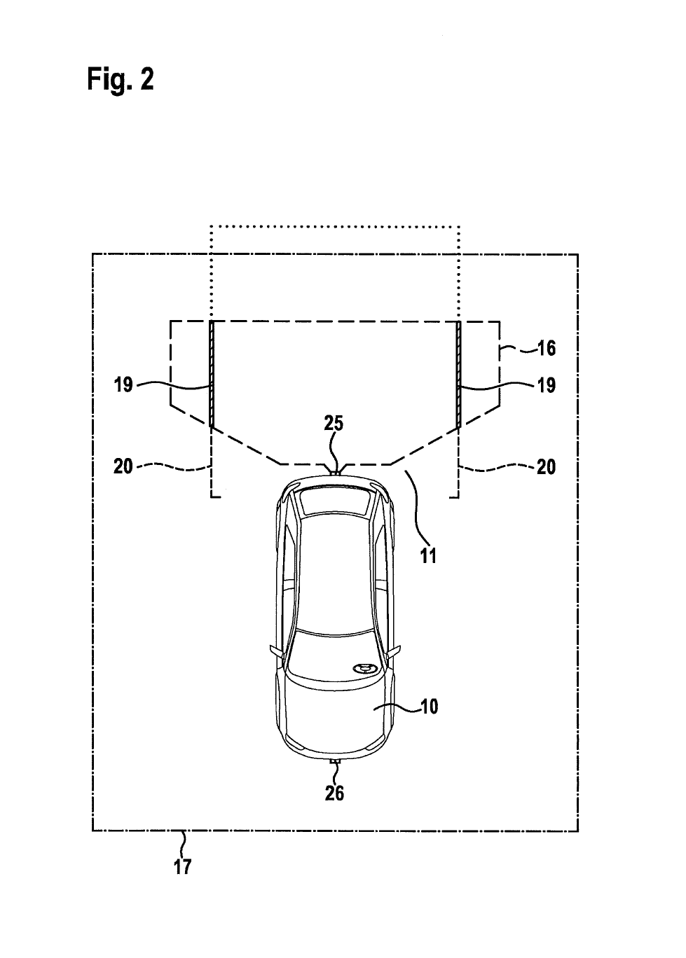

FIG. 2 shows vehicle 10 at second instant 18. Between first instant 14 and second instant 18, the vehicle was moved in reverse in the direction of parking space 11. Second region 16 sensed at second instant 18 once again has been identified by dashed lines. At second instant 18, first elements 15 are no longer sensed by first image sensor 25 within second region 16. The position of these first elements 15 was calculated with the aid of algorithms based on the movement compensation for second instant 18. In FIG. 2 these first elements 15 are shown at second instant 18 in the form of virtual first elements 20 as dashed lines. Second elements 19 within second region 16 are sensed by first image sensor 25 at second instant 18.

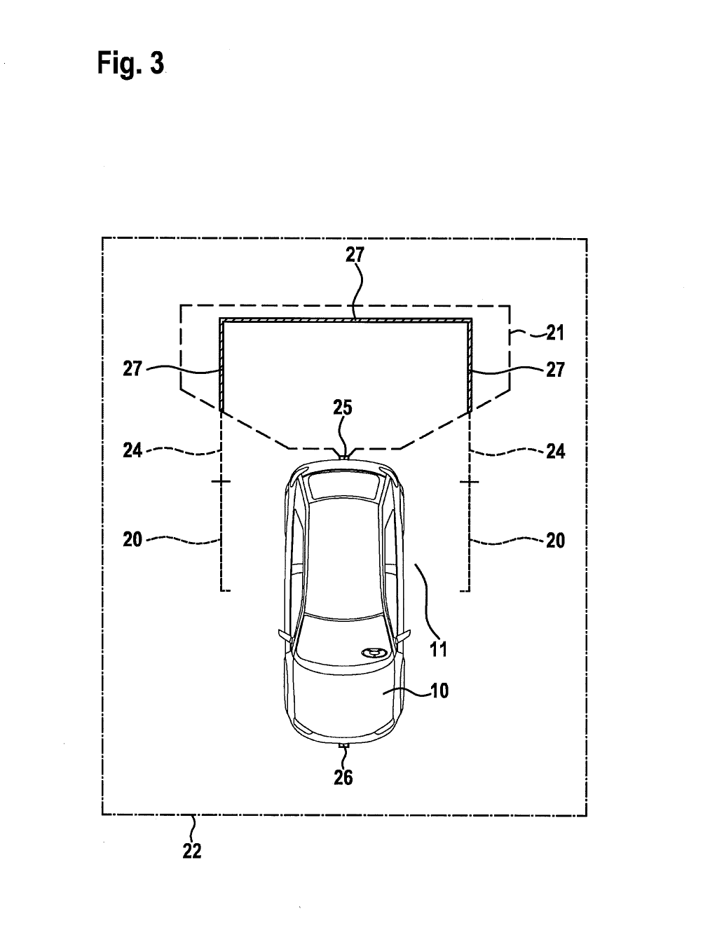

FIG. 3 shows vehicle 10 at a third instant 23. In addition to virtual first elements 20, virtual second elements 24, too, are marked in the form of dashed lines. Third elements 27 sensed at third instant 23 by first image sensor 25 represent the end region of the marking of parking space 11. Vehicle 10 has entered parking space 11 approximately halfway at third instant 23. Although only third region 21, i.e., the end region of parking space 11, is able to be sensed by first image sensor 25, i.e., the rear travel camera, the complete marking or boundary of parking space 11 is shown in third image 22.

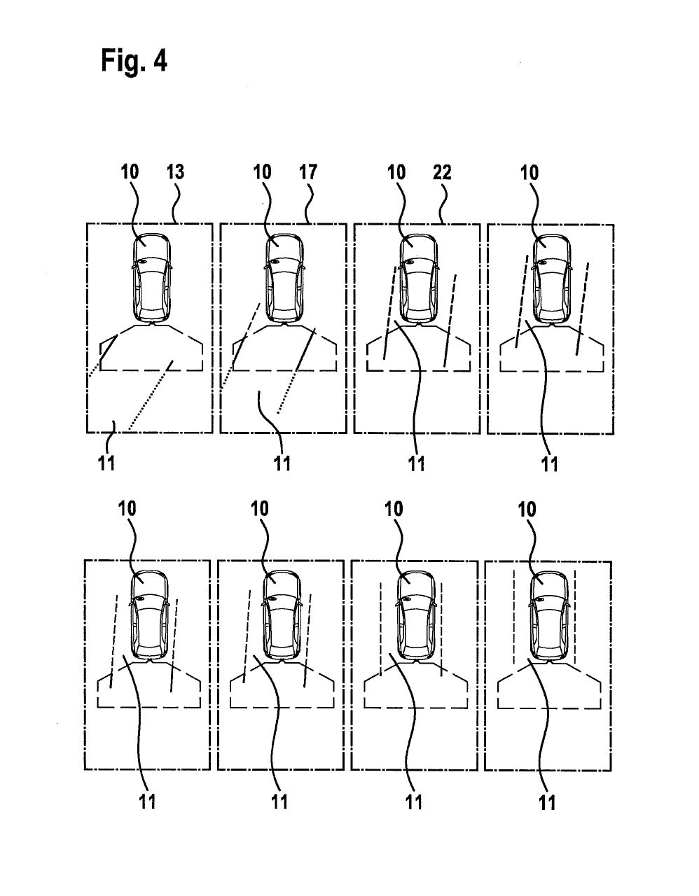

FIG. 4 shows a sequence of multiple successive images in a parking maneuver of a vehicle 10 traveling in reverse. The various images represent successive points in time. Parking space 11 once again is identified by markings (lines) on the ground. The lines detected and the lines that lie outside the current region at the current point in time are characterized as virtual elements in the form of dashed lines.

1-10. (canceled)

11. A method for maneuvering a vehicle into a parking space, comprising:
a) sensing a first region using a first image at a first instant;
b) at least one of: i) detecting at least one first element within the first region in the first image, and ii) storing the first image;
c) sensing a second region using a second image at a second instant, the second region lying at least partially outside the first region, and the second instant lying after the first instant;
d) at least one of: i) calculating a position of the first element detected in the first image at the first instant in relation to the second instant, the position lying outside the second region, and ii) calculating the position of the first image in relation to the second instant; and
e) inserting at least one of the first image and the first element as a virtual first element into the second image at the position calculated in step d) and displaying the second image.

12. The method as recited in claim 11, further comprising:
f) at least one of: i) detecting at least one second element in the second region in the second image, and ii) storing the second image;
g) sensing a third region using a third image at a third instant, the third region lying at least partially outside the second region, and the third instant lying after the first instant and the second instant;
h) at least one of: i) calculating a position of the second element, detected in the second image at the second instant, in relation to the third instant, the position lying outside the third region, and ii) calculating the position of the second image in relation to the third instant; and
i) inserting at least one of the second image and the second element as virtual second element into the third image at the position calculated in step h), and displaying the second image.

13. The method as recited in claim 12, wherein the steps f) through i) are repeated at predefined time intervals, so that mutually abutting or partially overlapping further regions are sensed using further images at successive points in time, and at least one of: i) the further images are stored, ii) further elements in the further regions are detected in the further images, and iii) positions of the further images and elements are calculated in relation to a following point in time in each case and are inserted as virtual further elements into the current image and displayed.

14. The method as recited in claim 11, wherein the first element is a static structure, the static structure including at least one of a line, a curb stone edge, a parked vehicle, a bollard, or an another structures bounding a parking space.

15. The method as recited in claim 11, wherein the part of the first region sensed using the first image and not overlapping with the second region is displayed in the second image and outside the second region.

16. The method as recited in claim 11, wherein the calculating of the position of the first element detected in the first image at the first instant in relation to the second instant is based on a movement compensation, and is based on at least one of: i) a translation of the vehicle, ii) a yaw angle of the vehicle or a camera disposed in or on the vehicle, iii) a pitch angle of the vehicle or a camera disposed in or on the vehicle, and iv) a roll angle of the vehicle or a camera disposed in or on the vehicle.

17. A maneuvering assistance system for parking of a vehicle, comprising:
a first image sensor, disposed on or in the vehicle and in the rear region of the vehicle, for sensing the first region by using a first image, the first image sensor being oriented toward a rear of the vehicle;
wherein the system is configured to:
a) sense a first region using a first image at a first instant;
b) at least one of: i) detect at least one first element within the first region in the first image, and ii) store the first image;
c) sense a second region using a second image at a second instant, the second region lying at least partially outside the first region, and the second instant lying after the first instant;
d) at least one of: i) calculate a position of the first element detected in the first image at the first instant in relation to the second instant, the position lying outside the second region, and ii) calculate the position of the first image in relation to the second instant; and
e) insert at least one of the first image and the first element as a virtual first element into the second image at the position calculated in step d) and display the second image.

18. The maneuvering assistance system as recited in claim 17, wherein the maneuvering assistance system has a second image sensor, disposed on or in the vehicle and in a front region of the vehicle, to sense the first region using the first image, the second image sensor being oriented toward a front of the vehicle.

19. The maneuvering assistance system as recited in claim 17, wherein the maneuvering assistance system includes no more than one first image sensor, the one front image sensor being one of i) a reverse travel camera or a front camera, or ii) the maneuvering assistance system includes no more than two image sensors, the two image sensors including a reverse travel camera and a front camera.

20. The maneuvering assistance system as recited in claim 17, wherein the maneuvering assistance system includes sensors for sensing translation of the vehicle.
